(19) United States
(12) Patent Application Publication
(10) Pub. No.: US 2026/0050238 A1
(43) Pub. Date: Feb. 19, 2026

(54) REPLICATING DEVICE FOR COPYING HOLOGRAMS INTO LIQUID PHOTOPOLYMERS

(71) Applicant: Carl Zeiss Jena GmbH, Jena (DE)

(72) Inventors: Mirko Riethmüller, Jena (DE); Markus Giehl, Jena (DE); Annett Barth, Jena (DE); Stefan Schwedat, Jena (DE)

(21) Appl. No.: 19/103,815

(22) PCT Filed: Aug. 17, 2023
(86) PCT No.: PCT/EP2023/072643

§ 371 Date: Feb. 13, 2025

(30) Foreign Application Priority Data
Aug. 18, 2022 (DE) 10 2022 120 865.6

(51) Int. Cl. G03H 1/02; G03H 1/18; G03H 1/20

(52) U.S. Cl. CPC G03H 1/0256; G03H 1/0248; G03H 1/181; G03H 1/202; G03H 2001/185; G03H 2223/25; G03H 2227/04; G03H 2240/55; G03H 2250/35; G03H 2250/39; G03H 2260/12

(57) ABSTRACT

A device for continuously replicating a hologram has a coating module to coat a liquid photopolymer onto a first carrier film, a lamination module to apply a second carrier film to the first carrier film coated with the photopolymer to obtain a photopolymer composite including a liquid photopolymer layer between two carrier films, an exposure module having a light source, and a master element with a master hologram to be replicated, and a fixing module to cure the replicated hologram in the photopolymer composite. The master element is axially rotatably mounted, and the exposure module is designed to bring the photopolymer composite in optical contact with the master element, while the light source exposes the master hologram to obtain a replicated hologram in a region of the photopolymer composite.

The invention relates to an apparatus for continuous replication of a master hologram into a liquid photopolymer.

The apparatus of the invention comprises a coating module set up to coat a liquid photopolymer onto a first carrier film, a laminating module set up to apply a second carrier film to the first carrier film coated with the photopolymer, in order to obtain a photopolymer composite comprising a liquid photopolymer layer between two carrier films, an exposure module comprising a light source and a master element, wherein the master element has a master hologram and is mounted so as to be axially rotatable. The exposure module is set up to bring the photopolymer composite into optical contact with the master element while the light source is exposing the master hologram onto a region of the photopolymer composite in order to obtain a replicated hologram. The apparatus additionally comprises a fixing module set up to cure the replicated hologram in the photopolymer composite.

### BACKGROUND AND PRIOR ART

The invention relates to the field of replication of holograms.

Modern microoptical methods permit integration of functions such as imaging or optical monitoring by means of holographic optical elements (HOE) inconspicuously into large-format glass surfaces.

HOEs typically denote optical components in which holographic properties are used to attain a specific beam path of the light, for example transmission, reflection, diffraction, scattering and/or deflection, etc. As a result, desired optical functionalities may be implemented in any desired substrates in a compact manner. The holographic properties preferably exploit the wave nature of light, in particular coherence and interference effects. Both the intensity and the phase of the light are taken into account here.

Such holographic elements find use in many fields, for example in transparent displays (for example in display windows, refrigeration equipment, vehicle windowpanes), for illumination applications, such as information or warning signals in glass surfaces, light-sensitive detection systems for example for interior monitoring (eye tracking in vehicles or presence status tracking of persons in interiors).

WO2020157312A1 discloses an example of a HOE that has been integrated into a vehicle windowpane. The hologram incorporated in the pane can serve as waveguide that directs incident light to a detector. The hologram is produced from a photosensitive material, for example photosensitive glasses, dichromate gelatins or photopolymers. These can be applied, for example, to a polycarbonate film and exposed correspondingly thereon. The film can then be laminated onto a substrate for the waveguide in order to produce the waveguide and then to be laminated onto a vehicle windowpane.

WO2018054985 A1 discloses a volume hologram integrated in the tail lights of a vehicle in order to impart an unmistakable appearance thereto. For this purpose, the volume hologram may be exposed into a holographic layer, for example comprising photopolymers, and be applied directly to a tail light as a film. The volume hologram may provide both a color filter function and a beamforming function. In order to achieve this, a suitable composition of light-sensitive materials may be chosen. The thickness of the hologram may also be selected such that it works as a white light reflection hologram, with selection of a wavelength for reconstruction from an offered spectrum.

WO2016202595A1 discloses a holographic element which is produced as HOE layer in a spectacle glass. By integration of an HOE in the pair of spectacles, relevant data can be displayed to the user, or an optical functionality can be implemented. For this purpose, a liquid photopolymer is coated onto a surface of the glass substrate before it is exposed. In order to make a sufficient contribution to the optical function, for example to the strength of the spectacles, preference is given to using a photopolymer thickness between 50 and 100 μm. The addition of dyes to the photopolymer also allows the layer to be configured such that it fulfills a color-filtering function. In some embodiments, the photopolymer layer is provided on a carrier film before being applied to the glass, for example with a Bayfol® HX film from Covestro AG. The holographic layer is sealed by applying further layers. The total thickness of the spectacles can thus be kept low.

As apparent from the examples, HOEs, because of their space-saving design and various functionalities, can be used for a multitude of applications. There is therefore a need for replication methods, suitable for mass production, for holograms that can preferably be integrated into a wide variety of different components, especially glass surfaces. However, the holographic elements produced must have different properties here depending on the application, for example light sensitivity, layer thicknesses or material choice compositions. With regard to the above examples, it may be necessary, for example, that different properties of the holographic elements are required between spectacle lenses of different colours or strengths or between tail lights of different brands or models. There is therefore a need for efficient mass production of holographic elements having different properties-preferably without the need to use multiple different apparatuses for production of the holograms or to adjust them in a complex manner.

The production of holographic optical elements as insert parts generally requires the use of a carrier substrate and a light-sensitive layer. The traditionally used light-sensitive layer is a dichromated gelatin. A preferred alternative is the use of photopolymers, which are generally obtainable in dried form in the film composite in particular sizes, thicknesses and compositions which have been optimized for various purposes, for example in order to be exposed to light of a particular wavelength.

EP3065002B1 discloses a method of producing holographic security elements. Each holographic security element is built up stepwise, with provision of a carrier film having a replication layer. The application layer has a relief structure which is produced by embossing. A photopolymer in liquid form is applied to the replication layer in order to fill the valleys of the relief structure. A doctor blade is used to partly remove the photopolymer from regions of the relief structure, such that the photopolymer layer can have a varying thickness. The layer structure is then conducted across the lateral surface of a cylindrical master element such that the liquid photopolymer layer comes into contact with the lateral surface. In some embodiments, the lateral surface has a further relief structure which is transferred to the liquid photopolymer layer by means of pressure. At the same time, the master element is exposed in order to write a volume hologram in the liquid photopolymer layer. The formability of the photopolymer serves for production of a security element having both a relief structure and a volume hologram. After the photopolymer layer has been cured in an exposure station, an adhesive film is applied to the surface thereof.

DE102006016139 A1 discloses a further method of mass production of holographic security elements. The holographic security elements here too are built up stepwise and comprise a liquid photopolymer layer. This is contacted with a relief structure of a master element, in order to emboss the relief structure into the security element. At the same time, a master hologram is replicated by exposure into the liquid photopolymer layer.

The provision of liquid photopolymer layers during contacting with a master element is motivated in EP3065002B1 and DE102006016139 A1 by desired transfer of a relief structure.

However, the exposed photopolymer layer is also associated with drawbacks. Firstly, the methods have elevated sensitivity to mechanical influences. Secondly, the nature and properties of the photopolymer used are limited since viscosity or consistency of the liquid photopolymer may need to be adjusted in order to achieve a stable layer thickness, a stable relief structure and/or low adhesion to the master element. Moreover, thorough cleaning or the use of repellent coatings on the master element are necessary to prevent buildup of photopolymer residues.

WO2019/215272A1 discloses a further method of mass production of holographic security elements. The starting material used for the production of the holographic elements is a light-sensitive film. This is preferably in the form of a composite composed of two polymer films between which there is a dried heat-stable photopolymer. The photopolymer is then subsequently exposed by a conventional method. Especially in cases in which no embossing method is to be conducted, this starting material for the exposure of volume holograms is more mechanically robust than the deformable alternatives comprising liquid photopolymers that make contact with the master elements, and avoids photopolymer residues.

Holographic films comprising a film substrate and a light-sensitive photopolymer layer are commercially available, for example, from Covestro Deutschland AG in the form of the Bayfol® product series. WO2018/206503A1 discloses, by way of example, a production method for the provision of a film-bound photopolymer film for exposure with a hologram. The light-sensitive film contains a layer structure comprising a curable protective layer C, a dried photopolymer layer B and a carrier layer A. This is said to afford stable photopolymer films into which replication of the holograms is additionally enabled in a simple manner.

However, since the production of the light-sensitive films is generally separate from exposure and fixing, these film composites have to be mass-produced beforehand with the desired properties. Adjustment of the properties of the film composite comprising the photopolymer is disadvantageously not directly possible. Instead, for each change in layer thickness, carrier substrate or photopolymer sensitivity, new development of a light-sensitive film is necessary.

Especially in the case of holograms in preliminary and small-scale mass production, this is exceedingly disadvantageous if, for specific holographic systems for example, special adjustments are necessary in the film-bound photopolymer and the additional requirement for development work adds to the overall costs.

Furthermore, the use of conventional hologram exposure methods leads to a slower replication process which is sensitive to mechanical and positioning errors.

EP0896260A2 discloses an example of a method and apparatus for the copying of holograms. For this purpose, a master hologram in the form of a ground glass screen is arranged parallel to a light-sensitive film. According to the type of hologram, a laser is positioned, which scans the master hologram line by line. During this method, it is important that the position of the film remains stable relative to the master hologram. The holograms are exposed one after another, and the periods of interruption slow the process. Similarly to WO2019/215272A1, EP0896260A2 also uses a prefabricated light-sensitive film as starting material. The properties of the film can no longer be adjusted subsequently for processing reasons, but have to be developed and manufactured separately with altered properties. Economic implementation of preliminary or small-scale mass production is possible only with difficulty, if at all.

As an alternative to prefabricated light-sensitive films, there have been some suggestions in the prior art to apply the liquid photopolymers directly to the product into which an HOE is to be integrated. The method according to DE102019130022A1 for integration of a hologram into a pane composite with a curved geometry and the abovementioned method of production of spectacles from WO2016202595A1 are examples of such an in situ coating operation.

However, the method proposed is complex and not procedurally efficient since the coating cannot be continuous. The method is additionally slowed in that each substrate has to be cleaned prior to coating and activated by a plasma pretreatment. Moreover, it is difficult in this method to precisely establish a desired layer thickness of the photopolymer layer.

There is therefore a need for a faster and higher-quality apparatus for serial replication of holograms that can then be integrated in a simple manner into various components in an application-dependent manner, and in which adjustments that are not time-consuming and costly are possible for establishment of desired properties of the replicated holograms.

### OBJECT OF THE INVENTION

It is an object of the invention to provide an apparatus for continuous replication of holograms without the disadvantages of the prior art. In particular, it was an object of the invention to provide an apparatus capable of replicating holograms with high precision and speed, where the apparatus simultaneously features a high degree of flexibility for establishment of desired properties of the replicated holograms.

### SUMMARY OF THE INVENTION

The problem is solved by the features of the independent claim. Advantageous configurations of the invention are described in the dependent claims.

The invention relates to an apparatus for continuous replication of a hologram, comprising
a. a coating module set up to coat a liquid photopolymer onto a first carrier film,
b. a laminating module set up to apply a second carrier film to the first carrier film coated with the photopolymer, in order to obtain a photopolymer composite comprising a liquid photopolymer layer between two carrier films,
c. an exposure module, where the exposure module has a light source and a master element comprising a master hologram to be replicated,
wherein the master element is mounted so as to be axially rotatable and the exposure module is set up to bring the photopolymer composite into optical contact with the master element while the light source is exposing the master hologram onto a region of the photopolymer composite to obtain a replicated hologram, and
d. a fixing module set up to cure the replicated hologram in the photopolymer composite.

The providing of a replication apparatus with the aforementioned modules allows the liquid photopolymers advantageously themselves to be used directly as starting material for the replication. It is preferably additionally possible to mix the photopolymers in situ and to supply the finished mixture to the coating module (also referred to synonymously as “application module” in the context of the invention). Alternatively, the coating module is supplied by means of a finished liquid photopolymer mixture which is stored in the dark. The liquid photopolymers can thus be changed between successive series or be provided with different additives. It is thus possible to use a wide range of liquid photopolymers in the same apparatus and to adjust it with regard to desired properties of the resulting polymer composite. Instead, the known procedure to date in the prior art was to conduct the replication in already finished polymer composites, the properties of which cannot be altered readily.

The possibility of the apparatus of the invention implementing replication of the holograms into still-liquid photopolymers opens up much higher process flexibility instead. With the aid of the apparatus of the invention, it is possible in particular in a simple manner to adjust process parameters such as a layer thickness of the photopolymer composite, the light sensitivity thereof or properties of the carrier films to the respectively desired applications. The possibility of rapidly altering these properties without providing prefabricated light-sensitive films allows production of holograms in small-scale runs to be made economically viable.

Advantageously encompassed within an apparatus for this purpose are a coating module for applying a liquid photopolymer to a first carrier film, a laminating module for applying a second carrier film, an exposure module for writing the hologram into the liquid photopolymer, and a fixing module for curing. The apparatus may advantageously be supplied with, in particular, different compositions of liquid photopolymers that are designed for the desired exposure conditions. It is likewise possible to define the desired layer thickness of the photopolymer composite by means of the coating module. The process procedures that follow, such as the exposure or the curing of the photopolymer, can be adjusted by means of the modules that are correspondingly downstream in the apparatus.

The providing of an apparatus that performs continuous replication of the holograms in a roll-to-roll method additionally enables high process speeds with simultaneously low propensity to error. An operator need not intervene during a run. Adjustments have to be made preferably only between the runs. This is particularly advantageous over the known prior art, where a master hologram above a liquid photopolymer layer has to be positioned and adjusted not just between the runs but also between the individual replications.

The providing of a laminating module in the apparatus makes it easily possible to adjust the film thicknesses and carrier film properties between the runs. The liquid photopolymer can be sealed between two films by the lamination, in order to assure high stability and to avoid soiling. The lamination also protects the liquid photopolymer from unwanted deformation by shear forces. This reduces propensity to errors in the production of the holograms.

The apparatus additionally has the particular feature of an exposure module with a master element mounted in an axially rotatable manner, such that the photopolymer composite is brought into optical contact with the master element while the light source is exposing the master hologram onto a region of the photopolymer composite in order to obtain a replicated hologram. “Contacting” in this sense is based on optical contact, although additional mechanical contact may also be preferred. The master element mounted in an axially rotatable manner especially permits continuous incorporation of the exposure process into a roll-to-roll method. Interruptions to the process, as in conventional methods using ground glass screens as master holograms, are avoided.

The providing of a rotatable master element allows repeated exposure of the master hologram or multiple master holograms at a speed which is additionally synchronized in a simple manner and exceedingly precisely with the process flow of a photopolymer composite. The exposure method can be performed rapidly and continuously by means of the axially rotatable master element without pausing between the individual replication steps. Adjustment of the position of a light-sensitive object to the master hologram may likewise be facilitated. The elevated exposure speed additionally reduces faults caused by light from the outside and thus leads to a more accurate replication process.

The equipping of the apparatus with a fixing module also leads to an improvement in the precision of the replicating operation. Since the liquid photopolymers are sensitive to mechanical perturbations, provision of the fixing module in the same apparatus facilitates transfer of the exposed liquid photopolymer from the master hologram to the fixative in a particularly rapid and unperturbed manner, which avoids possible mechanical or electromagnetic distortion.

Because of the rapidity and precision of the apparatus, no drying station is required between the coating and the exposure modules. Small runs can thus be produced in a more economically viable manner.

In the context of the invention, a “module” preferably refers to a working station in a continuous manufacturing method, preferably equipped with the required technical means for performance of the method step. Different modules may, but need not, be separated from one another by a housing or dividing wall.

“Lamination” in the context of the invention is preferably a cohesive thermal joining method without auxiliary materials such as adhesives. Im Sinne der Erfindung wird dies auch als “Kaschierung” bezeichnet, während das Laminierungsmodul auch als “Kaschiermodul” bezeichnet wird. The laminating module preferably comprises at least one laminating drum which is heated to 5-300° C., preferably 15-200° C. or else 20-100° C. At these preferred temperatures, particularly effective lamination can be conducted, and the liquid photopolymer can additionally cool down rapidly prior to exposure. The lamination is preferably designed so as to establish a permanent bond between the first and second carrier films, preferably by partial melting along one or both uncoated edges of the carrier films. The liquid photopolymer is then preferably sealed between the carrier films.

It is particularly preferable that the liquid photopolymer is cooled to a temperature of less than 40° C. prior to exposure, in order to assure optimal replication quality of the master hologram in the liquid photopolymer. The exposure of liquid photopolymers at lower temperatures promotes the writing of diffraction patterns that remain stable in the material.

A “composite” in the context of the invention is preferably a multilayer material consisting of two or more different components having different physical properties, bonded to one another at an interface. Preferably, the bond between the individual components is such that it is not separable by the action of a small force and is therefore deemed to be permanent.

“Exposure” in the context of the invention should preferably be considered to mean controlled steering of electromagnetic beams toward a correspondingly sensitive surface, preferably for formation of a hologram. Various methods of exposing a hologram are known; these include transmissive or reflective techniques for production of volume holograms. Examples thereof will be elucidated in detail later on in this text.

In the context of the invention, a “light source” (or “radiation source”) is preferably an apparatus for release of electromagnetic radiation that serves for exposure in particular. The electromagnetic radiation emitted may comprise visible light and/or radiation having wavelengths outside the visible range of the electromagnetic spectrum. The light source preferably emits a coherent light beam.

A “master element” is preferably a three-dimensional unit which comprises a master hologram in a form which ensures that any movement of the master element leads directly to a corresponding movement of the master hologram. When the “master element” is referred to as “axially rotatable”, this preferably means that the master element in the exposure module is mounted so as to be rotatable along an axis. An axially rotatable mounting therefore characterizes a mounting that enables rotation of the master element by its axis. The axis is preferably in the middle of a cross section of the master element, such that the master element can rotate in a space-saving manner. The master element is preferably prismatic, meaning that it has a constant cross section of any desired shape, e.g. square, polygonal, elliptical or circular. The ends of the master element that have the shape of the cross section can be referred to as the “main surface”. The elongate face of the master element between the two ends can be referred to as “lateral face”.

A “master hologram” in the context of the invention is preferably a holographic optical element comprising at least one hologram to be replicated. The master hologram is designed for an optical function (e.g. diffraction, reflection, transmission and/or refraction) for one or more wavelengths. For this purpose, for example, a plurality of holograms, each of which, for example, diffracts light of one wavelength, and/or multiplex holograms which diffract light at a plurality of wavelengths may be arranged as hologram stacks. The master hologram may be a diffractive optical element (DOE), for example. Diffractive optical elements (DOEs) use a surface relief profile with a microstructure for their optical function. Alternatively, the microstructure may also be present in the volume of the element in the form of a local difference in refractive index. The light transmitted by a DOE may be converted to almost any desired distribution by diffraction and subsequent propagation. This may involve an image, a logo, a text, a light refraction pattern or the like.

The process for producing the master hologram may preferably be referred to as “hologram origination” or “hologram mastering”. The master hologram may be created by an analog or digital method. In one illustrative analog method, a first coherent beam, the object beam, is reflected off an object onto a recording material, which is simultaneously subjected to a second coherent beam, the reference beam. The object beam and the reference beam interfere and create an interference pattern on the recording material. This interference pattern or stripe pattern is recorded by the light-sensitive material and, following the processing, adopts the shape of a surface relief pattern on a surface of the material or of spatially varying refractive indices only a few micrometers beneath the surface. In order to view an image of the original object, the master hologram may be illuminated with light that is diffracted by the recorded surface relief pattern or refractive index pattern. This diffracted beam contains the image of the original object. The master hologram can then be used as a new object when creating further copies with the same image.

The master hologram may preferably be computer-generated. The microscopic gratings which generate the diffraction effects may be produced, for example, by laser interference lithography. In this technique, two or more coherent light beams are configured such that they interfere at the surface of a recording material. The positions of the light beams with respect to the recording material may be controlled by a computer. Depending on the intensity of the laser, the recording material may consist of almost any material. Other techniques such as electron beam lithography may likewise be used for the digital production of the master hologram. The master hologram may preferably comprise glass, silicon, quartz, UV lacquer, a photopolymer composite and/or a metal such as nickel.

In the context of the present invention, the term “liquid”, or a liquid photopolymer, is preferably defined as a substance which is subject to continuous deformation when a shear stress of any size acts thereon (page 13, Munson et al. Fundamentals of Fluid Mechanics, Wiley: 2010). A liquid may preferably also be characterized by its viscosity and may be distinguished from other semisolid substances.

The dynamic viscosity of the liquid photopolymer used as raw material at 300 K is preferably between 0.2 mPas (millipascal second)-200 Pas (pascal second), more preferably between 1-10 000 mPas. The dynamic viscosity of the liquid photopolymer at the time of the exposure is preferably between 0.2 mPas and 200 Pas. It may be preferable to precrosslink the liquid photopolymer after application to the carrier film and prior to exposure, and to convert it to a viscoelastic state.

The viscoelastic state of the liquid photopolymer may be characterized here by its complex viscosity. The real part η′ of the complex viscosity correlates with the viscous properties or liquid characteristics (and what is called the loss modulus G″), while the imaginary part η″ correlates with the elastic properties or solids content (and the storage modulus G′). In preferred embodiments, the material properties of the liquid photopolymer during exposure are such that the ratio between a stored component (solid-state characteristics) or storage modulus G′and a loss component (liquid characteristics) or loss modulus G″ is at least 1:10. The higher the stored component in the ratio, the more favorable the effect on exposability in the replication process. In preferred embodiments, the ratio of storage modulus G′ to loss modulus G″ is at least 1:5, at least 1:2, 1:1, 2:1, 5:1 or more. The ratio between the storage modulus G′ and loss modulus G″ is preferably not more than 10:1. Within these parameter limits, it is possible to achieve particularly good results with regard to the stability of the photopolymer during exposure and quality of the replicated holograms. The ratio can be established by adjustments in the composition of the photopolymer, for example by addition of thixotropic agents, precrosslinking of the photopolymer or evaporation of solvents after application of the liquid photopolymer to a first carrier film and before coverage of the liquid photopolymer with a second carrier film and lamination thereof. The viscoelastic properties of the liquid photopolymers can also be optimized by cooling the liquid photopolymer before or during exposure.

“Fixing” preferably means a process step for curing of a liquid material, especially a liquid photopolymer, preferably by introduction of electromagnetic and/or thermal energy into the material. The energy can preferably be applied uniformly to a surface of the sensitive material in order to assure simultaneous curing. Preferably, all layers of the photopolymer composite, especially comprising the photopolymer layer, are solidified at this stage.

The general way of working of some components of the apparatus of the invention will now be elucidated in detail in sequence, before discussing particular details of the preferred embodiments.

Because of the high processing speed of the apparatus, it is possible to use liquid photopolymers with a low storage stability of a few days, hours or minutes. These liquid photopolymers should preferably be handled with extreme caution owing to their light sensitivity. The coating module is therefore preferably optically insulated from the ambient light.

The viscosity of the liquid photopolymers is preferably adjusted by mixing and/or by heating before they are supplied to the coating module. Light sensitivity, color sensitivity and any increase in refractive index of the liquid photopolymer are preferably also adjusted before it is supplied to the coating module. The coating module preferably enables adjustment of the thickness of an applied liquid photopolymer layer. This can be accomplished in various ways, for example by adjusting the flow rate out of a slot die or by adjusting the distance between adjacent drums. The coating module may be configured differently depending on the rheological properties and the desired thickness of the liquid photopolymer layer, as will be elucidated in detail later on. The apparatus preferably comprises several coating mechanisms arranged in succession, such that only the particular mode of coating is employed for the run. This has the advantage that a much greater range of possible photopolymer layer thicknesses is possible, which can be adjusted between the runs.

The carrier film to which the liquid photopolymer is applied is preferably optically transparent, especially for applications in transparent displays. Preference is given to using a polycarbonate material, although it is also possible to use a multitude of other materials as disclosed in detail herein. At least one of the first and second carrier films is preferably glass-clear, transparent and very substantially uncolored.

The apparatus of the invention additionally comprises a laminating module set up to apply a second carrier film to the first carrier film coated with the photopolymer, in order to obtain a photopolymer composite comprising a liquid photopolymer layer between two carrier films. The composition of the photopolymer is preferably configured such that it does not cure during a laminating operation. The first and second carrier films are preferably configured as a web (of any length), such that the laminating module is set up to finish a composite web (of any length) comprising a liquid photopolymer layer.

The apparatus of the invention further comprises an exposure module, wherein the exposure module has a light source and a master element comprising a master hologram to be replicated, wherein the master element is mounted so as to be axially rotatable and the exposure module is set up to bring the photopolymer composite into optical contact with the master element while the light source is exposing the master hologram onto a region of the photopolymer composite to obtain a replicated hologram.

“Optical contact” should preferably allow a beam path of light to pass between the photopolymer layer and the master hologram without experiencing substantial perturbation or absorption. Direct cohesive contact between the photopolymer composite and the master element is possible but not mandatory. Instead, it is possible to provide, between the master element and the photopolymer composite, an interlayer which is preferably transparent to light from the light source of the exposure module, for example in the form of a transparent film.

The exposure for replication of the master hologram in the exposure module may be based on various techniques. Hologram replication methods can be divided into relief holograms and volume holograms.

Relief holograms are formed by physical contact between a deformable sensitive layer and a master hologram such that the diffraction pattern of the master hologram is impressed in the sensitive layer.

A volume hologram is written into a sensitive layer, preferably by the interference of two light beams (called a reference beam and an object beam). A volume hologram is preferably written into the liquid photopolymer layer. This can preferably be effected by transmittance or reflection methodology. Interference of object and reference beams within the hologram volume preferably gives rise to a sequence of Bragg planes. Therefore, a volume hologram preferably has a non-negligible extent in the direction of propagation of the light rays, where the Bragg condition is applicable in the reconstruction using a volume hologram. It is for this reason that volume holograms have a wavelength selectivity and/or angle selectivity. The ability of volume holograms to store multiple images at the same time allows production of colored holograms inter alia. Light sources emitting in the three primary colors of blue, green and red can be used for the recording of the holograms. The three bundles of rays preferably expose the photopolymer layer simultaneously at the same angles. Following the exposure, three holograms are stored in the volume hologram at the same time. The reproduction of the color hologram can exploit the fact that each partial hologram can only be reconstructed by the color with which it was recorded. Consequently, the three reconstructed color sectors are superimposed to form the colored, faithful image, provided that the color components are weighted correctly.

In the case of a reflection hologram, a direction of incidence of the reference beam (preferably an incident light beam from the light source) and the object (in this case the master hologram) may be disposed on opposite sides of the liquid photopolymer layer. A reference beam penetrates the liquid photopolymer, preferably enclosed in this case between two transparent carrier films, and is then reflected by the master hologram back into the liquid photopolymer layer. The master hologram may preferably be applied to a surface of the master element that is preferably not entirely transparent, but at least partly reflective. A transparent master element is likewise employable.

The light source for a reflection hologram may be arranged such that the reference beam is incident on the liquid photopolymer layer in a desired direction, preferably in a direction desired in the later reconstruction. In a preferred embodiment, the light source is oriented in relation to the master element in such a way that the photopolymer composite is disposed between the light source and the master element. For example, the light source may be aligned below the master element, such that the reference beam is incident upwardly on the lateral surface thereof in a particular direction. The reference beam is preferably reflected at least partly by the master element in the form of an object beam back into the photopolymer composite. Thus, the reference beam and the object beam enter the photopolymer composite from opposite sides and interfere in the photopolymer layer of the latter for replication of the hologram.

In a transmission hologram, the liquid photopolymer layer is preferably disposed in such a way that it can be exposed by a reference beam and object beam from the same side. The light source is preferably oriented in relation to the master element such that a light beam first passes through the master element and the master hologram before reaching the photopolymer composite. The arrangement is illustrative, and other arrangements are also conceivable. The light may preferably be arranged such that it passes from an opposite side of the lateral surface from the photopolymer composite through a preferably transparent master element. The incident light beam is preferably refracted by the master element so as to form a reference beam and an object beam, where the object beam preferably corresponds to the component of the light diffracted by the master hologram. The object beam preferably interferes with the undiffracted reference beam in the liquid photopolymer layer in order to replicate the hologram.

In a further embodiment of the invention, the exposure module may be set up for replication of the master hologram by edge lighting (edge-illuminated hologram). For this purpose, the master element is preferably provided in the form of an optical fiber, and the light source is preferably set up to direct light onto a main surface of the master element. As in the case of other arrangements for transmission holography, the light is preferably divided by the master element into a reference beam, which penetrates the master hologram without diffraction, and an object beam, which is diffracted by the master hologram. The light beam within the master element preferably propagates by reflections, preferably total reflections. The light losses in the regions of the lateral surface that are not in optical contact with the photopolymer composite are preferably reduced to a minimum. The majority of the light can preferably exit from the master element at a via a master hologram disposed on the lateral surface, in order to replicate the hologram into the photopolymer layer.

By virtue of the alignment of the light source onto a main surface, the apparatus can be arranged around the lateral surface in a particularly space-saving manner with maximum useful space. This space may be utilized for accommodation of the master hologram, additional optical layers and greater contact between master element and photopolymer composite. The alignment of the light onto a flat area of the master element additionally allows the apparatus to be made less sensitive to small changes in laser alignment, for example owing to vibrations.

In a preferred embodiment, the light source emits a coherent light beam. Coherence preferably refers to the property of optical waves whereby there is a fixed phase relationship between two wave trains. As a result of the fixed phase relationship between the two wave trains, spatially stable interference patterns can arise. With regard to coherence, a distinction can be made between temporal and spatial coherence. Spatial coherence preferably constitutes a measure of a fixed phase relationship between wave trains perpendicular to the propagation and exists for parallel light beams, for example. Temporal coherence preferably constitutes a fixed phase relationship between wave trains along the direction of propagation and exists in particular for narrowband, preferably monochromatic, light beams.

Coherence length preferably denotes a maximum path length difference or time-of-flight difference between two light beams from a starting point, in order that a (spatially and temporally) stable interference pattern still arises when they are superposed. The coherence time preferably refers to the time that the light needs to travel a coherence length.

In preferred embodiments, the light source is a laser. This is more preferably a narrowband, preferably monochromatic, laser with a preferred wavelength in the visible range (preferably 400 nm to 780 nm). Lasers preferably mean light sources which emit laser radiation. Non-limiting examples include solid-state lasers, preferably semiconductor lasers or laser diodes, gas lasers or dye lasers.

Other light sources, preferably coherent light sources, can also be used. Preference is given to narrowband light sources, preferably monochromatic light sources, including, for example, light-emitting diodes (LEDs), optionally in combination with monochromators.

The coherence of the light beams is of relatively minor relevance to the generation of relief holograms. Particularly for the replication of volume holograms, by contrast, it is preferable that the light beams used for replication are sufficiently coherent.

In preferred embodiments, the coherence length of the light source is preferably at least 150 μm, more preferably at least 500 μm and even more preferably at least 2 mm. The coherence length is preferably at least twice the distance between the photopolymer and the master hologram. With preference, however, the coherence length is also not so long that parasitic microstructures, such as perturbing gratings for example, occur in the hologram. The maximum preferred coherence depends on the hologram type and the geometric dimensions of the exposure module. In preferred embodiments, the coherence length of the light source is less than 1 m.

The light source may comprise two or more light sources. The latter may preferably be configured such that they scan a line or a region of the photopolymer composite in optical contact with the master element.

It is optionally possible to provide an apparatus for forming and/or guiding the light beam between the light source and the master element or the photopolymer composite. This may comprise any number or type of lenses, prisms, mirrors etc. The means of forming and/or guiding the light beam can distribute the light in such a way that it covers, for example, essentially a point, a line or an extended region. By means of an appropriate scanning unit, it is additionally possible to provide for scanning. The light source may preferably be configured such that it generates one or more beams that light the whole length of the lateral surface of the master element or preferably at least a length corresponding to the coated portion of the photopolymer composite by means of an expanded beam and/or by scanning.

The master element preferably has a prismatic shape, especially a cylindrical shape. Axial rotatability allows the master element preferably to function as a drum. This enables synchronous movement between the master and the light-sensitive photopolymer composite, such that the probability of positioning errors can be reduced. According to the materials used, a friction force between the photopolymer composite and the master element may be sufficient to bring about movement of the master element. In this case, the master element advantageously does not require a dedicated drive, and the movement is essentially passive via the movement of the photopolymer composite. Alternatively or additionally, a speed of rotation of the master element may be controlled separately via a suitable drive, where the drive assures synchronous movement of the surface of the master element with the photopolymer composite.

In a further preferred embodiment of the invention, the master element is driven either by transmission of force from a function drum, a flange-attached ring gear, a Cardan drive or a belt drive. The master element is preferably provided with a dedicated drive. In the case of a function drum, the force can preferably be transmitted by friction, where the function drum preferably comprises a rubber material. The drive mechanics are preferably designed such that the surfaces of the master element have maximum accessibility for an exposure beam. It is advantageous in the case of these drive techniques that essentially all surfaces of the master element can remain clear for optical functions. This enables a more efficient exposure method and the use of the same master element for the copying of different hologram types, according to the positioning of the light source.

In a further preferred embodiment of the invention, the master element is rotated synchronously with the web speed of the photopolymer composite web. What is preferably meant by “rotation of the master element synchronously with the web speed” of the photopolymer composite web is that the circumferential speed of the lateral surface of the master element is identical to the web speed of the photopolymer composite web. In this way, it is possible to prevent unwanted slippage between photopolymer composite web and the lateral surface of the master element or excessive web tension of the photopolymer composite web, such that the master hologram can be replicated into the photopolymer layer in a precise position and without distortion.

Web speed with regard to the photopolymer composite web preferably refers to the speed of the photopolymer composite web or carrier film in longitudinal direction through the apparatus. Longitudinal direction is preferably defined by the longest dimension of the photopolymer composite web and preferably corresponds to the main direction in which the photopolymer composite web is moved through the apparatus. Web speed may be the speed of a point on the carrier film or photopolymer composite web. Circumferential speed preferably refers to the speed of a point on the lateral surface of the master element that performs a circular motion by virtue of the rotation thereof, and can also be referred to as unrolling speed.

In a further preferred embodiment of the invention, the abrasion of the master element is controlled by a control unit, especially in order to obtain a desired circumferential speed of the lateral surface of the master element.

In a preferred embodiment of the invention, the control unit is configured for retention of a desired web tension in the photopolymer composite web. This may be a web tension upstream of and/or beyond the master element. This can ensure that the photopolymer composite does not overextend, for example owing to too low a web speed of the photopolymer web upstream of the master element. It can also ensure that the photopolymer composite does not bend, for example owing to too low a web speed of the photopolymer web downstream of the master element. Mechanical introduction of defects into the photopolymer layer can thus be avoided.

In a particularly preferred embodiment of the invention, the control unit is configured to control drives of transport rollers (also referred to as “transport drums” in the context of the invention) for the movement of the photopolymer composite web to and from the master element, in order to maintain a desired web tension in the photopolymer composite web, especially upstream and downstream of the master element.

For this purpose, web tension is preferably monitored by suitable sensors. If web tension should be outside a permissible range, it is preferable that the control unit is configured for the purpose of adjusting the rotation speed of one or more transport rollers (rather than the master element). For this purpose, the control unit can send a signal to the drives of one or more transport rollers in order to bring the web tension back into the permissible range. The master element thus also plays the role of a “master” on the control side in relation to the web tension of the photopolymer composite web. The control unit is thus preferably designed to keep a desired speed of rotation of the master element constant, while drives of transport rollers or other components of the apparatus that affect the web speed of the photopolymer web are adjusted accordingly.

In the context of the invention, “web tension” is preferably a measure of the tensile stress to which the photopolymer composite web is subject in longitudinal direction, especially in the direction of movement thereof through the apparatus. It can be defined by the force that acts on the photopolymer composite web in longitudinal direction compared to the cross section of the photopolymer composite web and can be measured, for example, in N/mm².

The rotation of the master element synchronously with the flow speed or web speed of the photopolymer composite web enables a continuous and rapid replication method. This is particularly advantageous for the processing of the high-sensitivity liquid photopolymer layer since the still-liquid photopolymers are sensitive to ambient light, perturbation light or shear forces. The liquid photopolymers are fixed after a short period of exposure, and the continuous process can additionally avoid mechanical effects that cause warpage.

The apparatus of the invention further comprises a fixing module set up to cure the replicated hologram in the photopolymer composite. The fixing module can accept the composite web from the exposure module preferably rapidly and with minimal deflection. The fixing module may preferably comprise a light source, preferably UV radiation, and/or a heat treatment source. In the case of fixing with a UV lamp (also referred to as “UV source” in the context of the invention), the latter is preferably adjusted such that it emits intensive UV radiation between 315-400 nm onto the photopolymer layer.

The fixing module may be in the same housing as the exposure module. In a preferred embodiment, the apparatus is configured such that the fixing follows immediately after the exposure on the master element. Preferably, the distance between an incident electromagnetic beam from the exposure source and a fixing beam is less than 50 cm, preferably less than 10 cm, preferably less than 5 cm, even more preferably less than 1 cm. The fixing beam may be an expanded beam or may consist of one or more optionally scanning beams, and may preferably be arranged such that it is directed onto the master element and passes through the photopolymer layer disposed between the fixing beam source and the master element.

The apparatus preferably additionally comprises a control unit for control of the components of the apparatus, for example the coating module, the laminating module, the exposure module and/or the fixing module.

The term “control unit” preferably relates to any computation unit having a processor, a processor chip, a microprocessor or a microcontroller that enables automated control of the components of the apparatus, for example a speed of rotation of an unwinding roller, winding roller, lamination roller, transport roller, of a master element, or an adjustment of a photopolymer composition, a coating thickness, a lamination temperature, a lamination pressure, a compressive lamination force, an orientation and/or scanning speed of a light source, a fixing intensity, etc. The components of the control unit can be configured conventionally or individually for the respective implementation. The control unit preferably comprises a processor, a memory and a computer code (software/firmware) for control of the components of the apparatus.

The control unit may also comprise a programmable printed circuit board, a microcontroller or any other apparatus for receiving and processing data signals from the components of the apparatus, for example from sensors relating to the speed of the first or second carrier films, the master element or the photopolymer composite web, and other relevant sensory information. The control unit preferably further comprises a computer-usable or computer-readable medium, such as a hard disk, a random access memory (RAM), a read only memory (ROM), a flash memory, etc., on which computer software or a code is installed. The computer code or the software for controlling the components of the device may be written in any desired programming language or model-based development environment, for example in C/C++, C#, Objective-C, Java, Basic/VisualBasic, MATLAB, Python, Simulink, StateFlow, Lab View or assembler, without limitation thereto.

The phrase “the control unit is configured to” carry out a specific operating step, for example adjustment of the speed of rotation of the master element to the web speed of a photopolymer composite web or vice versa by varying the speed of one or more drive motors, may comprise customer-specific or standard software which is installed on the control unit and which initiates and controls these operational steps.

In preferred embodiments, the apparatus may have sensors, for example tension sensors for measuring the tension in the first and/or second carrier film. In these cases, the control unit is preferably set up to receive and optionally evaluate data from the sensors, for example tension sensors, for example in order to compare detected tension values with reference values. The control unit may preferably additionally be configured, by reference to an evaluation of the data process parameters, for example, to adjust the speed of one or more transport drums, for example by sending a signal to one or more drive motors, in order to balance out the tension between the first and second carrier films.

In a further preferred embodiment of the invention, the web tension of the photopolymer composite web is detected by suitable sensors and transmitted to the control unit. Web tension in the apparatus is preferably controlled by separation of tensile stress independently of web speed. The control of web tension is especially set up to maintain a constant web tension between the coating module and the exposure module. By means of a constant web tension, it is possible to avoid changes in length in the sections of the photopolymer composite web in question. Such changes in length are undesirable, especially while the photopolymer is still liquid, since these changes in length can lead to layer inhomogeneities such as “fish eyes”, sink marks, notable orange peel, etc. Maintenance of an essentially constant web tension is therefore particularly preferable in the sections of the apparatus after coating and up to the exposure, preferably up to fixing.

In preferred embodiments, the apparatus may comprise a motor to drive the master element, where the speed of rotation of the master element and/or the flow rate or web speed of the photopolymer composite and/or the web tension of the photopolymer composite web is detected by a sensor and transmitted to the control unit. The control unit in these cases is preferably configured such that it compares the speed of rotation of the master element with the web speed of the photopolymer composite and adjusts the speed of one or both elements in order to keep them in synchronous running of the web. Alternatively or additionally, the speed of rotation of the master element is controlled depending on the measured web speed of the photopolymer composite layer, in order to keep web tension within a preferred range.

Particularly preferred features of the apparatus will now be elucidated in detail. The sequence of elucidations does not necessarily correspond to the sequence of arrangement in the apparatus.

In a preferred embodiment of the invention, the exposure module is configured such that, while the photopolymer composite is being conducted through the exposure module, a region of the photopolymer composite to be exposed temporarily adopts the shape of a lateral surface of the master element in some regions and is conducted across the rotating master element moving with the lateral surface. Therefore, there is preferably mechanical contact between a region of the master element and a region of the photopolymer composite. What is meant by “across the rotating master element” is not a particular direction of the photopolymer composite in relation to the master element, but rather any direction that runs at least partly along the extent of the master element. The film composite may thus run above, below, to the left, to the right or diagonally relative to the master element, etc.

The shape of a lateral surface of the master element can be assumed temporarily only over a very small area. For example, the region to be exposed may take the form of a thin line with a line width of less than 1 mm, for example when the composite runs essentially tangentially to the lateral surface of the master element.

It is likewise possible for the region of the photopolymer composite to be exposed to temporarily adopt the shape of the lateral surface of the master element over an extended region, for example of an arc across a circle segment of a cylindrical master element having an opening angle of more than 5° or more than 10°. This offers additional space for exposure and optionally fixing. The exposure can preferably be effected in the exposed region along a line parallel to the axis of rotation of the master element, or simultaneously in several lines. The exposure is preferably effected by means of an expanded constant light beam or by means of one or more continuously scanning light sources, preferably lasers.

In a preferred embodiment, the light source(s) of the exposure module and the light source(s) for fixing (for example a UV source) of the photopolymer composite web are in the same optically insulated housing. The fixing can preferably be effected in the same extended region directly after the exposure. This enables a minimal transport distance between exposure and fixing, such that the exposed photopolymer spends a particularly small amount of time in a state of moderate viscosity after exposure. This reduces the risk of distortion that can occur during transport of the composite, for instance when the tension in the first and second carrier films is not equal and shear forces occur along the composite web.

Distortions in the photopolymer that is still of moderate viscosity lead to a reduction in resolution of an exposed image and consequently to a reduction in quality of the end product. These distortions are frequently caused by shear forces that act on the photopolymer and can deform the exposed microstructures. This occurs when, for example, one of the first or second carrier films is pulled more quickly than the other. It is therefore preferable that the tension in each of the upper and lower carrier films is measured and compared automatically, preferably prior to lamination, in order to ensure that these are synchronous and any errors can be corrected.

In a preferred embodiment, the apparatus comprises means of monitoring and controlling the tension in the films, in order to further reduce the probability of distortions caused by shear forces. The tension in the carrier films prior to lamination is preferably measured by one or more sensors, and the data are sent to a control unit that compares the tensions ascertained. The control unit preferably initiates a correction measure when the difference in tensions exceeds a defined value. The adjustment measure preferably comprises sending of a signal to one or more drive motors in order to alter the speed of rotation of a driven drum. The control unit may also evaluate data from the sensors in order to determine whether one or more carrier films has been trapped (rise in tension) or torn (drop in tension), in order to bring the apparatus to safe shutdown in either of the cases.

In a further preferred embodiment of the invention, the master element comprises a main body. The main body may be transparent, color-filtering or opaque. At least the lateral surface of the main body is preferably optically polished. A polishing level of P3 is preferable, although an even higher polishing level of P4 is even more preferred.

In a further preferred embodiment of the invention, the main body has a surface figure of not more than λ/2, especially in relation to the radiation generated by the light source. The surface figure in the context of the invention preferably corresponds to the difference between an actual shape of the main body and a target shape. The surface figure is preferably determined with the aid of a test glass of diameter 50 mm. For example, a test glass having a known diameter and known curvature is placed onto the surface of the main body. This arrangement is exposed to a laser of known wavelength, such that interference stripes are observable on the test glass. The interference stripes can be used to draw conclusions as to the variance in curvature of the main body from the known curvature of the test glass.

In a further preferred embodiment of the invention, a variance of the master element from an ideal cylindrical shape is not more than 0.2 mm, especially not more than 0.01 mm. This enables very precise deflection of light through the body or the surface of the master element. At the same time, the rotation of the master element can be synchronized very accurately with the movement of the photopolymer composite web.

In the case of an opaque main body, a master hologram preferably lies on a lateral surface of the main body. Such a main body may be completely or partly absorbing for the wavelength of the light source of the exposure module. It is preferable here that such a master element is configured for the copying of a volume hologram by a reflection method; in other words, the light source is arranged in such a way that the light as a reference beam runs through the composite and then through the master hologram, before being reflected again from the master hologram through the composite as object beam. In the case of an absorbing main body, it is advantageous that reflecting perturbations can be restricted to a minimum.

In the case of a transparent or color-filtering main body, a master hologram has preferably been introduced in or on a lateral surface of the main body. The main body preferably comprises optical glass, for example N-BK7, Borofloat glass, borosilicate glass, B270N-SF2, P-SF68, P-SK57Q1, P-SK58A, BK10, quartz glass and/or P-BK7 or optical plastic, for example polymethylmethacrylate (PMMA), polycarbonate (PC), cycloolefin polymers (COP) or cycloolefin copolymers (COC). Such a main body may preferably be employed for the copying of a volume hologram by a reflection or transmission method.

Irrespective of the material of the main body, there may be one or more master holograms present solely in one or more particular regions of the lateral surface. In order to avoid reflection perturbations, it is preferable that the master hologram-free regions of the main body are coated with a reflection-reducing material.

It may be preferable that an optical liquid is applied on a surface of the master element and/or the photopolymer composite. This preferably has an optical refractive index close to that of the master element, especially a cover of the master element, and/or the photopolymer composite, in order to minimize reflections at the interfaces between the master element and the photopolymer composite. Moreover, the optical fluid can improve optical contact between the elements since any defects in the shape and/or surface of the optical elements are balanced out.

In a further preferred embodiment of the invention, an optical adhesive film is temporarily introduced between master element and the photopolymer composite.

In a further preferred embodiment of the invention, the exposure module comprises at least one unwinding roller and one winding roller for temporary application of an optical adhesive film between the master element and the photopolymer composite. The unwinding roller preferably serves for the unwinding of the optical adhesive film, and the winding roller for the winding of the optical adhesive film after use. The optical adhesive film preferably temporarily bonds the composite (preferably at least for the period of exposure) to the master element, and advantageously creates an optical bond between the two elements. This has the advantage that unwanted reflections at the interfaces between the master element and the photopolymer composite are reduced, which gives rise to a higher-quality hologram. The optical adhesive film may also be referred to as OCA (Optical Clearance Adhesive).

The method preferably comprises a step of removing the optical adhesive film from the master element and/or from the photopolymer composite after exposure, where the apparatus preferably comprises suitable means for the removal-for example a winding roller.

In the context of the invention, an “optical adhesive film” is preferably a transparent film having a refractive index close to the refractive index of the master element and/or of the photopolymer composite. The optical adhesive film is preferably set up to improve optical contact between the master element and the photopolymer composite, so as to reduce or eliminate reflections at the interface between the master element and the photopolymer composite.

The materials used for the optical adhesive film preferably have identical or similar optical properties to those materials that are used for the substrate of the master element, coverage thereof and/or the composite web. The similar or identical properties preferably include transparency, haze, stress birefringence properties and/or refractive index. The use of identical or similar materials allows very close matching of the refractive index of the optical adhesive film to the refractive indices of the adjoining master element and/or photopolymer composite, such that a transition between the adjacent refractive indices without jumps in refractive index can be assured. It is possible in this way to largely eliminate or distinctly minimize reflections at the interface between the master element, the optical adhesive film and/or the photopolymer composite.

Furthermore, the optical adhesive film is preferably a solid in which Brownian motion of the molecules is sufficiently small, whereby “wobbling” of the phase of the light is prevented, and hence the result is a more stable interference field in the hologram copy within the exposure time. In this way, the microstructures do not smear, which maximizes the diffraction efficiency of the holograms. The sharpness and contrast of the hologram created are also distinctly improved. The optical adhesive film improves the optical contact between exposed transparent components through which the exposure light is guided. This reduces unwanted reflections, scattering or losses, and the quality of the reproduced hologram is increased.

The optical adhesive film may be formed analogously to the photopolymer composite—for example as a web—and be moved through the process in an analogous manner, for example with the aid of drums. This enables simple synchronization of the optical adhesive film with the photopolymer composite.

In contrast to the OCAs (optical clearance adhesives) known from the field of optical displays, the optical adhesive film preferably has a low adhesive power in addition to its advantageous optical properties. As a result, the optical adhesive film can be removed from a surface after use without residue and with little force.

In a preferred embodiment of the invention, the optical adhesive film comprises at least one adhesive layer. The at least one adhesive layer preferably has a peel force with respect to the surface of the master element and/or a surface of the photopolymer composite of less than 3 N/cm (newtons per centimeter), preferably of less than 1 N/cm. However, in preferred embodiments, the peel force of the adhesive layer of the optical adhesive film with respect to the surface of the master element and/or a surface of the light-sensitive composite web is at least 0.01 N/cm, preferably at least 0.1 N/cm. For example, the peel force of the optical adhesive film or one of its layers can be measured according to a 180 degrees peel test. In preferred embodiments, the measurement is in accordance with ASTM D903.

In a preferred embodiment of the invention, the optical adhesive film has a single-layer layer structure, where the layer structure comprises exactly one adhesive layer. The exactly one adhesive layer is preferably adhesive on both sides in order to impart optical contact.

In a preferred embodiment of the invention, the optical adhesive film comprises two adhesive layers, where each adhesive layer is preferably applied directly to a carrier layer such that the optical adhesive film comprises three layers. Such an optical adhesive film may adhere to two surfaces simultaneously, which can impart particularly good optical contact and reduce any risk of air gaps or unwanted reflections.

The optical adhesive film is preferably optically transparent. The optical adhesive film preferably comprises a material having a Fresnel-corrected transparency of at least 99%, a maximum haze of 0.5% and a minimal tendency to polarization. The material of the optical adhesive film is preferably colorless. It is particularly preferable that the optical adhesive film has no yellow tinge and no grayness. The bond strength of the optical adhesive film should be sufficiently small that no unwanted tensions arise in the photopolymer composite and no traces are left behind on the master element or the photopolymer composite. This means that the optical adhesive film is preferably detachable without residue. A preferred bond strength is between 10 cN/cm-3 N/cm for the optical adhesive film.

In preferred embodiments, the optical adhesive film comprises a carrier layer coated on both sides by an optically transparent adhesive material. A carrier layer is therefore preferably provided with adhesive layers on both sides, where the adhesive layers preferably consist of an adhesive material. The carrier layer preferably comprises one or more of the following materials: polycarbonate (PC), polyethylene terephthalate (PET), polybutylene terephthalate, polyethylene, polypropylene, cellulose acetate, triacetate (TAC), cellulose hydrate, cellulose nitrate, cycloolefin polymers, polystyrene, polyepoxides, polysulfone, cellulose triacetate (CTA), polyamide, polymethylmethacrylate (PMMA), polyvinylchloride, polyvinylbutyral, perfluoroethylenepropylene (FEP) or polydicyclopentadiene or mixtures thereof. The optically transparent adhesive material preferably comprises an adhesive material based on silicone, acrylate, rubber or mixtures thereof, particular preference being given to rubber-based adhesive materials.

It is preferable that the outer layers of the optical adhesive film are each protected with a protective film in their original state. Suitable unwinding rollers may be provided in order to unwind these protective films in the distance between the unwinding roller of the optical adhesive film and the master element.

It is preferable that a difference in refractive index between the master element and the optical adhesive film, preferably likewise between the master element and the adjoining photopolymer composite, is not more than 0.2, even more preferably not more than 0.1 and yet more preferably not more than 0.05. This enables distinctly improved control over the light diffraction of the exposure light without requiring optical fluids, which entail high maintenance intensity and frequent cleaning of the apparatus.

It is particularly preferable that the optical adhesive film has a refractive index between a refractive index of the master element (or cover thereof) and the adjoining photopolymer composite (or its adjoining carrier film). In this context, the word “between” preferably also includes the values of the refractive indices of the adjacent master element or photopolymer composite itself. This arrangement allows a smooth or unperturbed transition of light beams between the master element and the photopolymer composite with minimal reflections and/or aberrations at interfaces.

As an illustrative, nonlimiting example, the refractive indices, proceeding from the main body and in the radially outward direction, may be selected, for example, as follows:
main body (made of N-BK7): nₑ=1.519
adhesive layer: nₑ=1.51
master hologram (photopolymer layer): nₑ=1.500
master hologram (carrier film): nₑ=1.485
optical adhesive film (OCA consisting of adhesive layer/carrier layer/adhesive layer): nₑ=1.47/1.485/1.47

A person skilled in the art knows of further materials which, proceeding from the present teaching, enable a very substantially continuous transition of the refractive index of the master element and the adjoining carrier film. For example, in one alternative, the main body may comprise Borofloat-33, which has a refractive index of 1.48. The materials of the further layers can be selected so as to be matched to this index. It is generally preferable for all the abovementioned components (main body to optical adhesive film) that the respective refractive index is between 1.4 and 1.6.

For all the abovementioned components, the materials thereof preferably have a Fresnel-corrected transparency of at least 99%, a maximum haze of 0.5% and a minimal tendency to polarization. The stress-optical coefficient of the materials is preferably as small as possible. Stress birefringence of the materials is preferably minimized by appropriate heat treatments such that carrier films, when viewed through crossed polarizers, do not show a zebra pattern. It is also preferable that the materials used have a low level of streaks, inclusions and bubbles.

In a further preferred embodiment of the invention, the master element has a constant diameter of at least 50 mm, preferably at least 100 mm, more preferably at least 150 mm and even more preferably at least 300 mm. Advantageously, corresponding shapes and dimensions of the master element cause particularly low distortion resulting from shear stresses in the liquid photopolymer layer. The lower curvature which is caused by the greater diameter also enables elevated flexibility and control in the alignment of the exposure light and has a positive influence on any introduced input or shear forces in the photopolymer composite, meaning that they are lower.

Optionally, it is additionally possible for further transport drums to be provided in the apparatus between the exposure module and the fixing module. In order to conserve the exposed liquid photopolymer layer, it is also preferable in such a case that such drums have a greater constant diameter. Preferred diameters are at least 50 mm, preferably at least 100 mm, more preferably at least 150 mm and yet more preferably at least 300 mm. The optional transport drums are preferably aligned such that a web has very few deflections, if any, between the exposure module and the fixing module. This means that it is particularly preferable for the transportation of the exposed liquid photopolymer to run essentially in a straight line.

In a further preferred embodiment of the invention, one or both main surfaces and/or the lateral surface of the master element are fully or partly provided with an antireflection coating. This can advantageously reduce unwanted perturbations in the exposure as a result of reflections.

In a further preferred embodiment of the invention, the coating module is set up to coat the liquid photopolymer onto the first carrier film by means of a roll-to-roll method. The coating module may comprise one or more coating elements, where the suitable coating element may be selected according to the layer thickness and rheological properties. Preferred coating elements may advantageously be as follows: an anilox roller, a wire doctor, a profile rod, a slot die, a doctor blade, a chamber doctor blade, a comma bar and/or equipment for a doctor blade method.

The thickness of a photopolymer layer is preferably 1-200 μm. For photopolymer layers having thicknesses between 1-15 μm, it is preferable to employ an anilox roller in an intaglio printing method. For photopolymer layers having thicknesses between 7-40 μm, wire doctors or profile rods are preferred. If the layer thickness is between 40 and 100 μm, preference is given to using a slot die, a doctor blade or a comma bar.

In a further preferred embodiment of the invention, the apparatus comprises two coating modules, where a first coating module is set up to coat a first carrier film with a liquid photopolymer and a second coating module is set up to coat a second carrier film with a liquid photopolymer. The separate coating of two films and joining thereof allows relatively thin coating layers to be combined to give a thicker photopolymer layer. It is advantageous that thinner layers are degassed more quickly. The solvents in the coatings can also evaporate more quickly prior to the lamination process.

Furthermore, the coating of additional carrier films may enable the production of photopolymer stacks. For example, a stack of three liquid photopolymer layers each separated by a carrier film may comprise three different photopolymer compositions, where each composition is for example sensitive to light of a particular wavelength (preferably RGB).

In a further preferred embodiment of the invention, the apparatus comprises an unwinding station for unwinding of a carrier film supplied as a roll. It is preferable that the apparatus comprises unwinding stations for the respective first and second carrier films. It is also preferable that the carrier films are supplied to the apparatus between two protective films. The apparatus in this case preferably comprises unwinding rollers for the removal of one or more protective films before the carrier films are processed further. It is particularly preferable that the protective films are removed from the carrier films only on one side.

In a further preferred embodiment, the apparatus further comprises a surface pretreatment station, preferably following the principle of a plasma pretreatment station, between at least one of the unwinding modules and a coating module, especially between the unwinding modules and the coating modules. This advantageously improves the adhesion of the liquid photopolymer layer to the carrier films. The apparatus preferably comprises a first surface pretreatment station for a pretreatment of the first carrier film, and a second surface pretreatment station for a pretreatment of the second carrier film. If further films should be coated with a photopolymer or cover a photopolymer layer, the apparatus may preferably also comprise a surface pretreatment station for every further film that should come into contact with a photopolymer layer.

In a further preferred embodiment of the invention, the laminating module comprises at least one laminating drum, especially a pair of laminating drums. The at least one laminating drum is preferably configured to apply a pressure of 0.02-200 N/cm², especially 0.02-50 N/cm², to the two carrier films and the intervening photopolymer layer. The application of pressure is preferably monitored by a suitable sensor and preferably serves to control the laminating module. The sensor used for the pressure which is exerted by the at least one laminating drum may preferably be a film coating, where a pressure sensor is distributed over the entirety of a film (called a “pressure measurement film”). In this way, it is possible to determine the distribution of the pressure along a laminating drum, such that any incorrect alignment of the laminating drum can be recognized and corrected.

In a further preferred embodiment of the invention, the laminating module comprises a pair of laminating drums. It is preferable that the laminating module applies a compressive force between 10-20 000 N to the two carrier films and the photopolymer layer in between. The compressive force required preferably depends on the width of the carrier films, the coating width, the target layer thickness and/or web speed. Alternatively or additionally, the laminating module can laminate the at least two carrier films at a temperature between 5-300° C., preferably 15-200° C., especially 20° C.-100° C. The temperature is preferably chosen depending on the materials of the two carrier films such that one or both are brought to their melting point for a brief period of time. The preferred temperature depends not only on the aforementioned parameters but also on the photopolymer formulation. The temperature and pressure should preferably be adjusted such that the photopolymer layer remains in a liquid state, or a viscosity optimized for the further process steps is obtained or established. The laminating module preferably connects the first and second carrier films along two parallel uncoated edges, such that the liquid is trapped between them.

In a further preferred embodiment of the invention, one or both laminating drums comprises stainless steel. Stainless steel offers various benefits, for example the ability to withstand high pressures and ease of cleaning. The laminating drums may be rigid, for example without stainless steel coating and/or in that the stainless steel is coated solely with a protective layer and/or a pressure sensor. This is particularly advantageous when thin layers of liquid photopolymer are provided between the carrier films. In the case of relatively thick photopolymer layers, however, it may also be advantageous when the laminating drums have a less rigid coating. In some embodiments, it is therefore preferable that one or more of the laminating drums have a rubber coating, where the rubber coating may comprise, for example, a fluoro elastomer such as Viton or a nitrile rubber (acrylonitrile-butadiene rubber, NBR).

In a further preferred embodiment of the invention, the apparatus comprises a degassing station disposed between the coating module and the laminating module. The degassing station is preferably set up to transmit vibration to the coated first and/or second carrier film. The vibration advantageously serves to eliminate any air bubbles in the liquid photopolymer layer. The degassing station is preferably also configured to be heatable to 30-300° C., especially 100-200° C. The elevated temperature also serves to remove solvents. The degassing station may additionally be used to increase the viscosity of the photopolymer layer for subsequent process steps. This further reduces any effect of residual shear forces on the liquid photopolymer layer.

In all modules and stations of the apparatus, it is preferable that a web width of the carrier films or of the photopolymer composite between 150-1500 mm can be accommodated, where a coated width is preferably 100-1400 mm. For the transportation of the carrier films in web form or of the photopolymer composite, the apparatus preferably has web-guiding elements such as guide drums and/or a tension roller or tension drum. The web-guiding elements and the modules are preferably configured for a web speed between 5 cm/min and 50 m/min.

All modules and stations of the apparatus can preferably also be replicated. For example, the apparatus may have three successive exposure modules, for the exposure of three different color-sensitive constituents of the liquid photopolymer at different wavelengths. The apparatus may alternatively or additionally comprise three coating modules, laminating modules and exposure modules arranged in parallel, where these three process different color-sensitive photopolymer composites in order to establish a stack composed of three composites, e.g. an RGB stack, after fixing.

The apparatus of the invention is preferably set up to perform a method for continuous replication of a hologram. The method preferably comprises the following steps:
a. coating a first carrier film with a liquid photopolymer by means of a coating module,
b. applying a second carrier film to the coated first carrier film with the aid of a laminating module in order to obtain a photopolymer composite comprising a liquid photopolymer layer between two carrier films,
c. contacting a region of the photopolymer composite with an axially rotatable master element comprising a master hologram to be replicated in an exposure module, and exposing the region of the photopolymer composite by means of a light source, such that the master hologram is replicated onto the photopolymer composite, and
d. curing a replica hologram present in the liquid photopolymer in a fixing module.

The person of average skill in the art will recognize that technical features, definitions and advantages of preferred embodiments of the apparatus of the invention are also applicable to the method, and vice versa.

Another particular feature of the method is the contacting of the photopolymer composite with a master element mounted in an axially rotatable manner, while the light source exposes the master hologram onto a region of the photopolymer composite to obtain a replicated hologram. “Contacting” in this sense is based on optical contact, although additional mechanical contact may also be preferred. The master element mounted in an axially rotatable manner especially permits continuous incorporation of the exposure process into a roll-to-roll method. Interruptions to the process, as in conventional methods using ground glass screens, are avoided.

Because of the high processing speed, it is possible to use liquid photopolymers with a low storage stability of a few days, hours or minutes. These liquid photopolymers should preferably be handled with caution owing to their light sensitivity. The coating module is therefore preferably optically insulated from the ambient light. The high-speed processing of the photopolymers reduces the risk of perturbations caused by reflection and ambient light, such that the end product has high precision and quality. Because of the rapidity and precision of the apparatus, no drying station is required between the coating and the exposure modules. Small runs can thus be produced in a more economically viable manner.

The preferred steps of the method are elucidated in detail here. The sequence of elucidations that follows may but need not correspond to the sequence of method steps.

A first carrier film is preferably coated with a liquid photopolymer in a coating module. The thickness of a photopolymer layer is preferably 1-200 μm. For photopolymer layers having thicknesses between 1-15 μm, it is preferable to employ an anilox roller in an intaglio printing method. For photopolymer layers having thicknesses between 7-40 μm, wire doctors or profile rods are preferred. If the layer thickness is between 40 and 100 μm, preference is given to using a slot die, a doctor blade or a comma bar. The method may optionally comprise simultaneous coating both of the first and second carrier film by separate coating elements. The separate coating of two films and joining thereof allows relatively thin coating layers to be combined to give a thicker photopolymer layer. It is advantageous that thinner layers are degassed more quickly. The solvents in the coatings can also evaporate more quickly prior to the lamination process.

The method preferably further comprises applying a second carrier film to the coated first carrier film with the aid of a laminating module in order to obtain a photopolymer composite comprising a liquid photopolymer layer between two carrier films. The laminating module preferably comprises two laminating drums. It is preferable that the laminating module applies a compressive force between 10-20 000 N to the two carrier films and the photopolymer layer in between. The compressive force required preferably depends on the width of the carrier films, the coating width, the target layer thickness and/or web speed. Alternatively or additionally, the laminating module can laminate the at least two carrier films at a temperature between 20-300° C. The temperature is preferably chosen depending on the materials of the two carrier films such that one or both are brought to their melting point for a brief period of time. The preferred temperature depends not only on the aforementioned parameters but also on the photopolymer formulation.

The composition of the photopolymer and the pressure and temperature of the lamination are preferably chosen such that the photopolymer remains in a liquid state during a laminating operation, or a viscosity optimized for the further process steps is obtained or established.

The first and second carrier films are preferably configured as a web (of any length), such that the lamination finishes a photopolymer composite web (of any length) comprising a liquid photopolymer layer.

The method preferably further comprises contacting a region of the photopolymer composite with an axially rotatable master element comprising a master hologram to be replicated in an exposure module, and exposing the region of the photopolymer composite by means of a light source, such that the master hologram is replicated onto the photopolymer composite. In this method step, a region of the photopolymer composite to be exposed preferably temporarily adopts the shape of a region of a lateral surface of the master element. The photopolymer composite, preferably in web form, is preferably conducted here across the rotating master element. The speed of the web and the master element are preferably synchronized to one another. The synchronization may be conducted by a control unit as described above.

Therefore, there is preferably mechanical contact between a region of the master element and a region of the photopolymer composite. If the composite is conducted tangentially to the master element, this region is a line having a line width of less than 1 mm, for example. It is likewise possible for the region of the photopolymer composite to be exposed to temporarily adopt the shape of the lateral surface of the master element over an extended region, for example over an arcuate region across a circle segment of a cylindrical master element having an opening angle of more than 5° or more than 10°. This offers more space for exposure and optionally fixing. The exposure can preferably be effected in the exposed region along a line parallel to the axis of rotation of the master element, or simultaneously in several lines. The exposure is preferably effected by means of one or more continuously scanning light sources, preferably lasers.

The exposure may be followed by fixing, preferably on the master element. Because of the sensitivity of the exposed liquid photopolymer to distortion, it is particularly advantageous that the fixing immediately follows the exposure with minimal transportation between the two method steps.

The method preferably comprises curing a replica hologram present in the liquid photopolymer in a fixing module. The fixing module can accept the composite web from the exposure module preferably rapidly and with minimal deflection. The fixing module may preferably comprise UV radiation and/or a heat treatment source. The fixing module may be in the same housing as the exposure module. In a preferred embodiment, the apparatus is configured such that the fixing follows immediately after the exposure on the master element.

In a preferred embodiment of the invention, the first and/or second carrier film is based on a material or material composite selected from a group comprising polycarbonate (PC), polyethylene terephthalate (PET), polybutylene terephthalate, polyethylene, polypropylene, cellulose acetate, triacetate (TAC), cellulose hydrate, cellulose nitrate, cycloolefin polymers, polystyrene, polyepoxides, polysulfone, cellulose triacetate (CTA), polyamide, polymethylmethacrylate (PMMA), polyvinylchloride, polyvinylbutyral, polydicyclopentadiene, mixtures of two or more of the materials mentioned or co-extrudates comprising one or more of the materials mentioned, more preferably PC, PET and/or TAC.

In particular, it has been found that the aforementioned materials, especially also coextrudates composed of two or more of these materials, are exceedingly weathering-resistant, and preferably tear less easily and have fewer weak points over their extent. This improves the lifetime of the holograms created. The materials and properties of the carrier films may be chosen such that a very continuous transition of the refractive indices from the master hologram to the liquid photopolymer layer is assured, taking account of the properties of any interlayers.

In a preferred embodiment of the invention, the liquid photopolymer comprises
(i) at least one writing monomer;
(ii) a photoinitiator system; and
(iii) at least one organic component,
where the liquid photopolymer optionally further comprises one or more of the following components: a catalyst, a dye, a free-radical stabilizer, a solvent, a non-polymerizable component, a reactive diluent, a dye oxidant, a dye reductant, a bleach, a thixotropic agent, a nucleating agent and/or auxiliaries or additives.

Suitable liquid photopolymers are known to the person skilled in the art. For example, compositions for liquid photopolymers as disclosed in EP1779196B1 are suitable. In a preferred embodiment, the liquid photopolymer is binder-free. The writing monomer is preferably an ethylenically unsaturated monomer having the general formula:

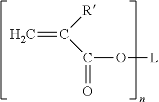

where n is 2 to 4, R′ is hydrogen or CH₃ and L is

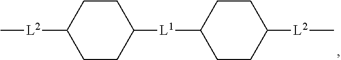

where the phenyl rings are optionally substituted by one or more substituents selected from the group consisting of halogen, C₁₋₄-alkyl, alkoxy or hydroxy;
L¹ is a covalent bond of a straight chain or branched C₁₋₄-alkyl group;
L² is a covalent bond, a straight chain or branched C₁₋₄-alkyl group which is optionally hydroxy-substituted, or -[L³-O]ₘ— where L³ is a C₁₋₄-alkylene group and m is 1 to 40;
where the at least one organic component is selected from the group consisting of castor oil, palm kernel oil, coconut oil and combinations thereof.

The liquid photopolymer component can preferably be mixed in situ. The amounts of the different components and the incorporation of optional components may be adjusted from run to run as required.

In a preferred embodiment of the invention, the dwell time of the liquid polymer during transportation of the photopolymer composite from the exposure module to the fixing module is not more than 10 minutes, preferably not more than 5 minutes, more preferably not more than 3 minutes.

In a further preferred embodiment of the invention, a dwell time of the liquid photopolymer between coating thereof on the first carrier film and curing thereof is not more than 15 minutes, preferably not more than 10 minutes, more preferably not more than 5 minutes.

The short dwell time of the photopolymer between the operating modules is advantageous since, in this way, all operating steps can be completed before distortions can occur in the hologram (for example because of mechanical effects on the liquid photopolymer) or other perturbing effects (for example owing to finite storage stability or optical perturbation light).

The apparatus of the invention and the preferred method provide a photopolymer composite, where the photopolymer composite comprises a photopolymer between two carrier films, in which a hologram has been replicated by the method and/or apparatus.

The person of average skill in the art will recognize that technical features, definitions and advantages of preferred embodiments of the apparatus of the invention and/or of the preferred method are also applicable to the photopolymer composite producible, and vice versa.

### DETAILED DESCRIPTION

The invention will be elucidated in detail hereinafter by examples and figures, without being limited thereto.

### BRIEF DESCRIPTION OF THE FIGURES

FIG. 1 schematic diagram of the apparatus of the invention and of the preferred method in a preferred embodiment

FIG. 2 schematic diagram of the exposure module in a further preferred embodiment

FIG. 3 schematic diagram of an arrangement of the exposure module for replication of a hologram by reflection

FIG. 4 schematic diagram of an arrangement of the exposure module for replication of a hologram by transmission, where the master element is exposed from a lateral surface

FIG. 5 schematic diagram of an arrangement of the exposure module for replication of a hologram by transmission, where the master element is exposed from a main surface

### DETAILED DESCRIPTION OF THE FIGURES

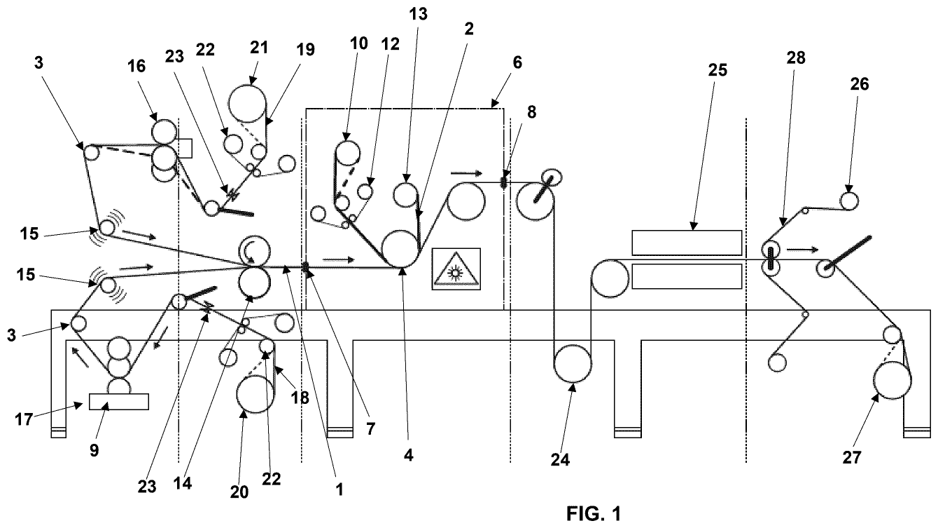

FIG. 1 shows a schematic of an apparatus in a preferred embodiment of the invention. The apparatus comprises two coating modules 16 and 17, one laminating module 14, one exposure module comprising a cylindrical master element 4 and a laser, and a fixing module 25. The apparatus is preferably designed for flow in web form of the carrier films 18, 19 or of a photopolymer composite 1 in the arrangement shown from left to right. The entire apparatus is preferably shielded from outside light. The stations and processes that the web undergoes will now be elucidated in detail.

A first carrier film 18 is preferably supplied between protective films and in the form of a roll as starting material. The first carrier film preferably comprises polycarbonate and has a preferred thickness between 50 and 125 μm. The width of the film is preferably up to 1500 mm, but more preferably up to 310 mm. In this way, the entire width in the continuation of the method can generally be covered with a single plasma pretreatment unit. An unwinding roller 20 conducts the first carrier film 18 to a coating module. In a section of the web between the unwinding roller and a coating module, a set of winding rollers 22 may be provided for removal of the protective films from the carrier film. Although it may be preferable for the protective film to be removed only from the side of the carrier film 18 to be coated, it is removed from both sides in this illustrative embodiment.

It is preferably possible to provide a plasma pretreatment station 23 between the winding rollers 22 and the coating module 17. This preferably prepares the side of the carrier film 18 to be coated in order to improve adhesion of a liquid photopolymer 9 on the surface thereof. The pretreated carrier film is then supplied to a first coating module 17.

In the embodiment shown, analogous stations and method steps are likewise provided for a second carrier film 19. The second carrier film may preferably comprise polycarbonate and has a preferred thickness between 50 and 125 μm. This is likewise unrolled from an unwinding roller 21, the protective films thereof are removed by rollers 22, and it is subjected to a plasma pretreatment and then supplied to a second coating module 16. The web speed through the pretreatment station is preferably 1-10 m/min.

In the embodiment shown, two coating modules are provided, the first coating module 17 an anilox roller which is suitable in particular for thin coatings (having a layer thickness between 1 and 15 μm). The second coating module 16 comprises a comma bar, which is suitable for thicker coatings in particular (having a layer thickness between 40 and 100 μm). In order to cover wider thickness ranges, the apparatus may, for example, alternatively or additionally comprise a further wire doctor or profile rod for coating of the upper and/or lower carrier films (not shown). It is not obligatory for both carrier films to be coated. As required for the run to be produced, the desired coating module may be switched on. The coating modules are preferably supplied with a liquid photopolymer 9 either from a reservoir vessel or a mixing unit (not shown). In preferred embodiments, these may also form part of the apparatus, in order to permit particularly rapid adjustment of the photopolymer formulation. The coating of the films may preferably be configured such that a coating-free edge is conserved at the sides of each film. This enables easier handling and facilitates the later laminating operation.

After passing through the coating module, each carrier film is conveyed via a transport drum 3 to a degassing station 15. In the degassing station, the carrier films are preferably induced to vibrate by means of vibrating drums, which results in escape of bubbles from the viscous liquid layer. Since the liquid photopolymer 9 may additionally contain a solvent, the latter may also be drawn off at this station. For this purpose, it may be preferable that the degassing station into additionally heats the carrier films to a temperature between 30 and 300° C. The degassing station may therefore simultaneously function as an evaporation unit (for solvents). The heating can be effected, for example, by means of a heated transport drum or by means of a heatable transport zone. The evaporation of the entirety or a portion of the solvent component may also be configured such that a viscosity of the liquid photopolymer is adjusted in order to facilitate the further processing steps. Advantageously, a more viscous liquid photopolymer layer is less prone to deformation by shear forces and reduces unwanted distortions in the replication process.

The two carrier films 18 and 19 are subsequently transported to a laminating module 14. The laminating module 14 preferably comprises a pair of laminating drums, one or both of which are adjustable in their position, in order to define a maximum thickness of the materials flowing in between. The laminating drums preferably comprise silicone and may have, for example, a diameter of up to 50 to 200 mm. The laminating drums may preferably be heated to a temperature between 5 and 300° C., preferably 15 to 200° C. If the target temperature for the heating should be equal to or less than ambient temperature, there is of course no requirement for active heating. The laminating drums are preferably also configured such that these exert a compressive force between 10 and 20 000 N on the carrier films and the photopolymer layer in a sandwich-like arrangement. The photopolymer composite is then optionally actively cooled to a room temperature, preferably to 20-25° C. The control unit preferably controls the required heating and/or cooling on the basis of the process requirements for the respective run and the ambient conditions.

The laminating module is preferably configured so as to form a photopolymer composite 1 from the three layers 19, 9 and 18. The photopolymer composite 1 flows preferably continuously from the laminating module 14 into a closed housing 6 containing at least the exposure module. The entry 7 to the housing may itself have a pair of positionable drums. The housing contains at least the master element 4 and a light source. The housing is preferably optically insulated. The degree of optical insulation may be determined here by the requirements of the exposure. Especially in the case of high web speeds, ambient light does not tend to perturb the exposure process, and so complete darkness is not required.

Entry 7, master element 4, a transport drum 3 and exit 8 are preferably arranged such that the photopolymer composite 1 is deflected by the master element 4. The master element is cylindrical here and is mounted so as to be rotatable about a center of its circular cross section. The photopolymer composite 1 is guided in particular over a section of the lateral surface on a bottom side of the master element, where a region of the photopolymer composite to be exposed temporarily adopts the shape of a lateral surface of the master element at least in some regions and is conducted across the rotating master element moving with the lateral surface.

In this embodiment, the region of the photopolymer composite 1 to be exposed temporarily adopts the shape of the lateral surface of the master element 4 over an extended region, where the extended region extends in the form of an arc across a circle segment of a cylindrical master element having an opening angle of more than 5°, preferably more than 10°.

Advantageously, in this case, it is possible to dispense with a dedicated drive for the master element. Since the movement of the carrier film causes a friction force across the surface of the master element (optionally imparted by an adhesive layer), this may be sufficient to bring about synchronous rotation of the master element 4 with the photopolymer composite 1. In this way, it is additionally possible to ensure particularly good exposure conditions and to achieve procedurally efficient implementation.

In the embodiment shown, an optical adhesive film 2 is also temporarily introduced as a web between the master element and the photopolymer composite web. The optical adhesive film 2 preferably consists of a carrier layer provided with an adhesive layer on both sides. In order to facilitate handling, the optical adhesive film 2 is preferably supplied in the form of a roll with a protective film on each side. The optical adhesive film is first preferably unrolled from an unwinding roller 10. The protective films are then removed by winding rollers 12. The optical adhesive film is conducted by the master element and a winding roller 13, which can optionally function as tension roller. In this way, a flow of the optical adhesive film 2 can be maintained synchronously with the flow of the photopolymer composite 1 across a surface of the lateral surface of the master element.

The optical adhesive film functions as an optical clearance adhesive (OCA) and ensures a smooth optical bond between a master hologram and the photopolymer composite 1. The master hologram is preferably mounted as a layer on an outer face of the master element.

The master hologram can preferably be replicated by means of a reflection or transmission process, in order to form a volume hologram in the still-liquid photopolymer 9. The position of the light source and of the light beam may be adjusted for the respective processes, such that the light beams either transmit through the master element and a master hologram present therein or thereon (transmission hologram) or are reflected by the master hologram back into the photopolymer composite (reflection hologram).

In the example of FIG. 1, the laser source is disposed beneath the master element and configured such that this replicates the master hologram by reflection. The master element is opaque, and the optical adhesive film is matched to the refractive index of the master hologram layer present on an outer surface of the master element. The carrier films 18 and 19 are both transparent in order that the light can pass through them to the master hologram, and the latter reflects the light back through all layers of the photopolymer composite. The laser can be configured such that it scans in an axial direction of the master element. The scanning speed may be matched to the web speed of the photopolymer composite 1.

Since the liquid photopolymer 9 just exposed is mechanically sensitive, the drums and guides over which it runs from the master element to the end of the fixing module are preferably configured such that they do not have any narrow-angle deflections. The radii of these drums 24 are preferably set to at least 100 mm, more preferably at least 200 mm and even more preferably at least 300 mm.

In order to prevent unwanted shear forces from acting on the liquid photopolymer layer, the apparatus additionally comprises tension sensors for maintaining an identical stress and strain state in the two carrier films 18 and 19. The exposed photopolymer composite leaves the opaque housing 6 via an exit 8. However, the photopolymer composite that has run through preferably remains protected from exterior light until it is fully fixed. The photopolymer composite is conducted by guide drums 24 to the fixing module 25.

The fixing module 25 preferably comprises one or two UV sources and a heating device. The fixing process is configured such that the liquid photopolymer layer is cured in order to fix the hologram. This is preferably accomplished rapidly, preferably within three minutes after exposure of the photopolymer, in order to prevent impairment of the quality of the ultimately fixed hologram. The air in the fixing module is preferably exchanged continuously by an air flow system.

After leaving the fixing module, the now cured photopolymer composite 1 with the hologram is preferably provided with a protective film 28 on both sides. If the outer protective film of the carrier films 18 and 19 has not yet been removed, it can be removed and replaced here. Unwinding rollers 26 feed the protective film to a working station comprising a set of rollers with adjustable separation. Finally, the finished photopolymer composite 1 is rolled up by an unwinding roller 27. Alternatively, the finished product containing one or more repeat holograms can be cut to size and stored in cassette form.

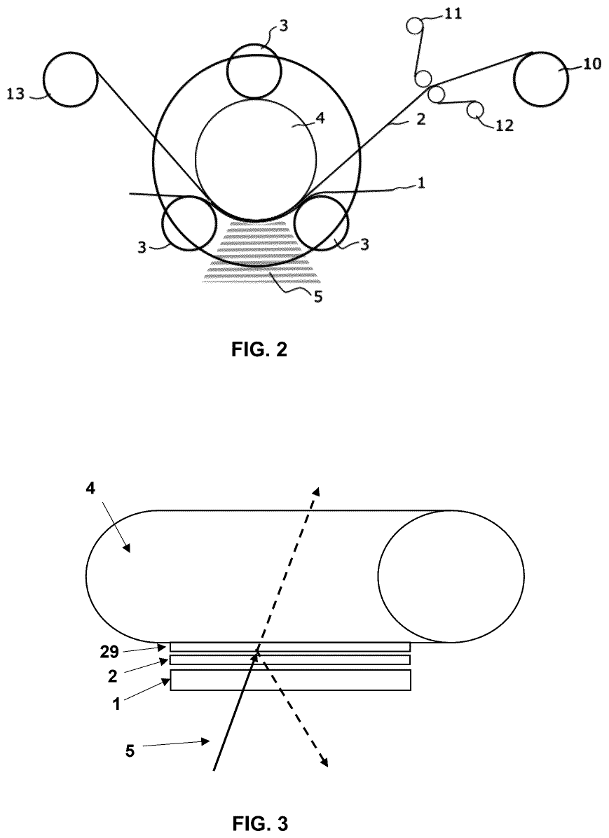

FIG. 2 shows an exposure module and method in a further preferred embodiment of the invention. In the embodiment shown, the photopolymer composite 1 is moved from right to left. The master element 4 is of cylindrical configuration with a constant diameter. The schematic diagram shows the circular main surface of the master element. A region of the photopolymer composite 1 to be exposed temporarily takes on the form of an area of the lateral surface and moves with the lateral surface while it is being conducted across the rotating master element. An optical adhesive film 2 is disposed as an interlayer between the master element 4 and the photopolymer composite 1. In this embodiment, the region of the photopolymer composite which is in contact with the lateral surface and is deformed thereby is fixed by the positioning of two lower transport drums 3. The exposure module additionally comprises an upper transport drum 3 which is in contact with the lateral surface of the master element. This drum is preferably manufactured from rubber and has a dedicated drive. The upper transport drum 3 transmits a rotary movement by friction to the master element 4 and determines the speed of rotation thereof. In this case, the movement of the master element 4 may be controlled actively and independently from that of the photopolymer composite 1. The controller is preferably set up such that synchronous movement of lateral surface and photopolymer composite is assured.

Alternatively, the master element 4 may also have a flange at one or both ends. The flange may be configured, for example, such that it interacts with a ring gear or a belt mechanism in order to move the master element. This has the advantage that both the lateral surface and the main surfaces of the master element are optically virtually completely accessible and flexible positioning of the light beams is enabled.

FIG. 3 shows a schematic of an arrangement of the light source in relation to the master element 4 in order to copy a master hologram 29 by reflection into a photopolymer composite 1. The light source is preferably arranged such that a light beam 5 is generated, which functions as reference beam and passes through the photopolymer composite 1 and an optical adhesive film 2 before being at least partly reflected by the master hologram 29. The reflected beam functions as object beam and passes through the optical adhesive film 2 and the photopolymer composite 1. The reference beam and the object beam preferably interfere in the liquid photopolymer layer in order to write the hologram. The angle at which the reference beam hits the master hologram may preferably correspond to the angle with which the copied hologram is illuminated in order to reconstruct the hologram, for example in a head-up display.

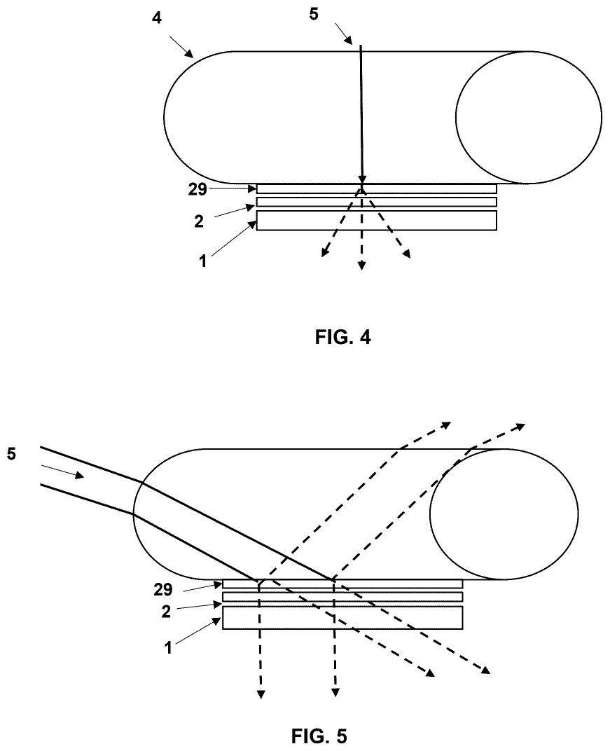

FIG. 4 shows a schematic of an arrangement of the light source in relation to the master element 4 in order to copy a master hologram 29 by transmission from a lateral surface into a photopolymer composite 1. The light source is preferably arranged such that a beam 5 generated by the light source passes through the master element 1, the master hologram 29, the optical adhesive film 2 and the photopolymer composite 1 as reference beam. The reference beam 5 is preferably partly diffracted by the master hologram 29 in order to generate object beams with different angles of attack on the photopolymer composite. The object beams preferably interfere with the undiffracted reference beam in the liquid photopolymer layer in order to replicate the hologram.

FIG. 5 shows a schematic of a further arrangement of the light source in relation to the master element 4 in order to copy the master hologram 29 by transmission into a photopolymer composite 1. In this embodiment, the light source is arranged such that a light beam 5 generated by the light source meets a main surface of the master element 4 (in analogy to an edge-lit configuration). The main surface preferably does not comprise a master hologram 29, which is instead present on the lateral surface.

The master element 4, for this embodiment, is preferably provided in the form of an optical fiber. As in the case of other arrangements for transmission holography, the light is preferably divided by the master element into a reference beam, which penetrates the master hologram without diffraction or with less diffraction, and an object beam, which is diffracted by the master hologram. The object beam and the reference beam interfere with one another in the liquid photopolymer layer in order to correspondingly alter the refractive index thereof and to write the hologram.

The light beam propagates within the master element preferably by reflections, preferably total reflections. The light losses in the regions of the lateral surface that are not in optical contact with the photopolymer composite are preferably reduced to a minimum.

### LIST OF REFERENCE SIGNS

1 photopolymer composite
2 optical adhesive film
3 transport drum (or “transport roller”)
4 master element
5 light beam
6 opaque housing
7 entry into opaque housing
8 exit from opaque housing
9 liquid photopolymer
10 optical adhesive film unwinding roller
11 winding roller for the protective film of the optical adhesive film
12 winding roller for the protective film of the optical adhesive film
13 optical adhesive film winding roller
14 laminating drum
15 degassing station
16 coating module (or “application module”)—comma bar
17 coating module (or “application module”)—anilox roller
18 first carrier film
19 second carrier film
20 unwinding roller for the first carrier film
21 unwinding roller for the second carrier film
22 protective film winding roller for the carrier films
23 pretreatment station (plasma)
24 guide drum
25 fixing module
26 protective film unwinding roller for the fixed hologram
27 winding roller for the fixed hologram
28 protective film for the fixed hologram
29 master hologram

1. An apparatus for continuous replication of a hologram, comprising:
a. a coating module configured to coat a liquid photopolymer onto a first carrier film (18),
b. a laminating module configured to apply a second carrier film to the first carrier film coated with the liquid photopolymer to obtain a photopolymer composite comprising a liquid photopolymer layer between the first and the second carrier films,
c. an exposure module, wherein the exposure module comprises a light source and a master element comprising a master hologram to be replicated,
wherein the master element is mounted so as to be axially rotatable, and the exposure module is configured to bring the photopolymer composite into optical contact with the master element while the light source is exposing the master hologram onto a region of the photopolymer composite to obtain a replicated hologram, and
d. a fixing module configured to cure the replicated hologram in the photopolymer composite.

2. The apparatus according to claim 1, wherein the exposure module is configured such that, while the photopolymer composite is being conducted through the exposure module, a region of the photopolymer composite to be exposed temporarily adopts the a shape of a lateral surface of the master element and is conducted across the rotating master element configured to move with the lateral surface.

3. The apparatus according to claim 1, wherein the master element comprises a main body, wherein the master hologram is inserted within the main body and/or applied to a lateral surface of the main body.

4. The apparatus according to claim 1, wherein the exposure module comprises at least one unwinding roller and one winding roller for temporary application of an optical adhesive film between the master element and the photopolymer composite.

5. The apparatus according to claim 4, wherein the optical adhesive film has a refractive index between a refractive index of the master element and the carrier film.

6. The apparatus according to claim 1, wherein the master element has a constant diameter of at least 50 mm.

7. The apparatus according to claim 1, wherein the master element is driven either by transmission of force from a function drum, a flange-attached ring gear, or a belt drive.

8. The apparatus according to claim 1, wherein one or both a main surface and/or a lateral surface of the master element is provided with an antireflection coating.

9. The apparatus according to claim 1, wherein the coating module is configured to coat the liquid photopolymer onto the first carrier film by a roll-to-roll method.

10. The apparatus according to claim 1, wherein the apparatus comprises two coating modules, where a first coating module is configured to coat a first carrier film with a liquid photopolymer and a second coating module is configured to coat a second carrier film with a liquid photopolymer.

11. The apparatus according to claim 1, wherein the apparatus comprises an unwinding station for unwinding of a carrier film supplied in roll form.

12. The apparatus according to claim 1, wherein the laminating module comprises a pair of laminating drums, and the second carrier film is laminated onto the coated first carrier film at a pressure between 0.02-200 N/cm², and/or temperature between 5-200° C.

13. The apparatus according to claim 1, wherein a degassing station is disposed between the coating module and the laminating module.

14. The apparatus according to claim 1, wherein a difference in refractive index between the master element and the optical adhesive film, and/or between the master element and the carrier film, is not more than 0.2.

15. The apparatus according to claim 11, wherein the apparatus further comprises a plasma pretreatment station between the unwinding station and the coating module.

16. The apparatus according to claim 13, wherein the degassing station is configured to transmit a vibration to the coated first and/or second carrier film.

17. The apparatus according to claim 13, wherein the degassing station is configured to be heatable to 30-300° C.
